(19) United States
(12) Patent Application Publication
(10) Pub. No.: US 2026/0005900 A1
(43) Pub. Date: Jan. 1, 2026

(54) ARTIFICIAL INTELLIGENCE BASED CHANNEL ESTIMATION FOR WIRELESS COMMUNICATION SYSTEMS

(71) Applicant: Samsung Electronics Co., Ltd., Suwon-si (KR)

(72) Inventors: Yan Xin, Princeton, NJ (US); Lucas Carrit Delgado Pinheiro, Hillsborough, NJ (US); William Xia, Ozone Park, NY (US); Murat Bayraktar, Raleigh, NC (US); Mandar Kulkarni, Bridgewater, NJ (US); Xiaochuan Ma, Hillsborough, NJ (US); Samuel Albert, Robbinsville, NJ (US); Yang Li, Plano, TX (US); Jianzhong Zhang, Dallas, TX (US)

(21) Appl. No.: 19/059,169

(22) Filed: Feb. 20, 2025

Related U.S. Application Data
(60) Provisional application No. 63/664,565, filed on Jun. 26, 2024.

(51) Int. Cl. H04L 25/02

(52) U.S. Cl. CPC H04L 25/0254; H04L 25/0204

(57) ABSTRACT

A method for channel estimation includes: receiving, by a first electronic device, a signal indicative of a state of a channel from a second electronic device, the signal being associated with a channel matrix and corrupted by a noise; obtaining a noisy image of the channel in a first domain, the noisy image being a least squares estimate of the channel matrix; transforming the noisy image into a second domain; and performing channel estimation (CE) of the channel based on (i) the transformed noisy image, (ii) a CE model configured to denoise an input signal, and (iii) a sparsity of channel state information (CSI) in the transformed noisy image in the second domain.

### CROSS-REFERENCE TO RELATED APPLICATION AND CLAIM OF PRIORITY

The present application claims priority under 35 U.S.C. § 119(e) to U.S. Provisional Patent Application No. 63/664,565 filed on Jun. 26, 2024, which is hereby incorporated by reference in its entirety.

### TECHNICAL FIELD

This disclosure relates generally to wireless networks. More specifically, this disclosure relates to artificial intelligence (AI) based channel estimation in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for AI based channel estimation in wireless communication systems.

In one embodiment, a method for channel estimation is provided. The method includes: receiving, by a first electronic device, a signal indicative of a state of a channel from a second electronic device, the signal being associated with a channel matrix and corrupted by a noise; obtaining a noisy image of the channel in a first domain, the noisy image being a least squares estimate of the channel matrix; transforming the noisy image into a second domain; and performing channel estimation (CE) of the channel based on (i) the transformed noisy image, (ii) a CE model configured to denoise an input signal, and (iii) a sparsity of channel state information (CSI) in the transformed noisy image in the second domain.

In another embodiment, a first electronic device is provided. The first electronic device includes a memory and a processor operably coupled to the memory. The processor is configured to: receive a signal indicative of a state of a channel from a second electronic device, the signal being associated with a channel matrix and corrupted by a noise; obtain a noisy image of the channel in a first domain, the noisy image being a least squares estimate of the channel matrix; transform the noisy image into a second domain; and perform channel estimation (CE) of the channel based on (i) the transformed noisy image, (ii) a CE model configured to denoise an input signal, and (iii) a sparsity of channel state information (CSI) in the transformed noisy image in the second domain.

In yet another embodiment, a non-transitory computer readable medium embodying a computer program is provided. The computer program includes program code that, when executed by a processor of a first electronic device, causes the first electronic device to: receive a signal indicative of a state of a channel from a second electronic device, the signal being associated with a channel matrix and corrupted by a noise; obtain a noisy image of the channel in a first domain, the noisy image being a least squares estimate of the channel matrix; transform the noisy image into a second domain; and perform channel estimation (CE) of the channel based on (i) the transformed noisy image, (ii) a CE model configured to denoise an input signal, and (iii) a sparsity of channel state information (CSI) in the transformed noisy image in the second domain.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example network device according to embodiment of the present disclosure;

FIG. 5 illustrates example full bandwidths via which sounding reference signals (SRSs) and physical uplink shared channel (PUSCH) demodulation reference signals (DMRSs) are transmitted in wireless communication systems according to embodiments of the present disclosure;

FIG. 6 illustrates a diagram of an example cyclic prefix (CP)-orthogonal frequency division multiplexing (OFDM) uplink system according to embodiments of the present disclosure;

FIG. 7 illustrates an example image being transformed into a delay domain according to embodiments of the present disclosure;

FIG. 8 illustrates a pipeline of an example artificial intelligence (AI)-based channel estimation method according to embodiments of the present disclosure;

FIG. 9 illustrates a pipeline of an example AI-based channel estimation method according to embodiments of the present disclosure;

FIG. 10 illustrates an example image denoising model according to embodiments of the present disclosure;

FIG. 11 illustrates an example image denoising model according to embodiments of the present disclosure;

FIG. 12 illustrates a pipeline of an example AI-based channel estimation method according to embodiments of the present disclosure; and

FIG. 13 illustrates a flowchart for an example AI-based channel estimation method according to embodiments of the present disclosure.

### DETAILED DESCRIPTION

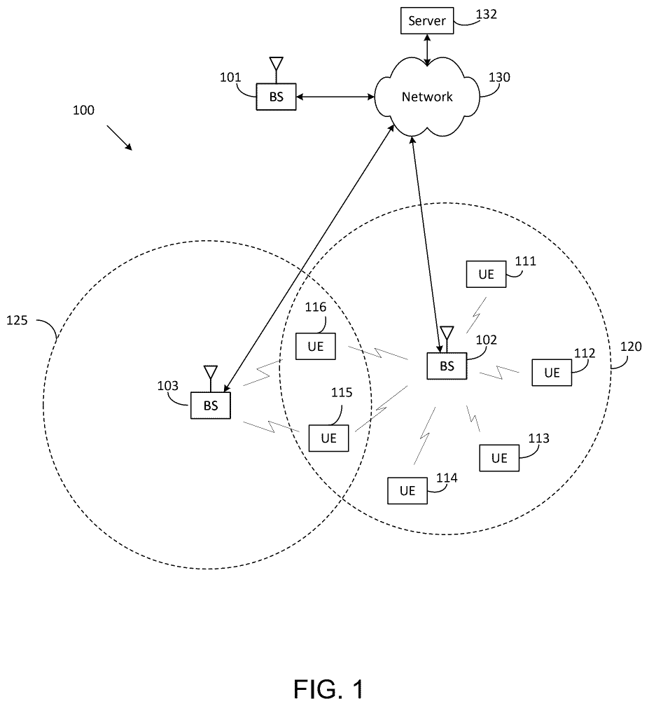

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 via backhaul/network interfaces and train an AI model to perform channel estimation. The server 132 may represent one or more servers, and each server 132 includes a suitable computing or processing device for training the AI/ML model. Each server 132 could, for example, include one or more processing devices, one or more memories storing instructions and data, and one or more network interfaces to receive the data. The AI model is then trained and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support AI-based channel estimation in wireless communication systems. In certain embodiments, one or more of the gNBs 101-103 include circuitry, programing, or a combination thereof, to utilize data preparation for AI/ML model training in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

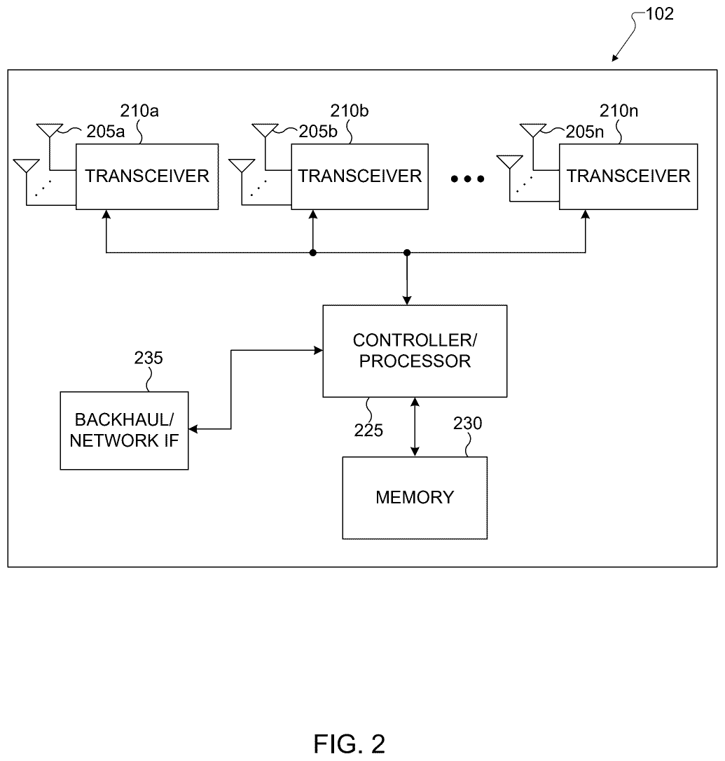

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI-based channel estimation in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

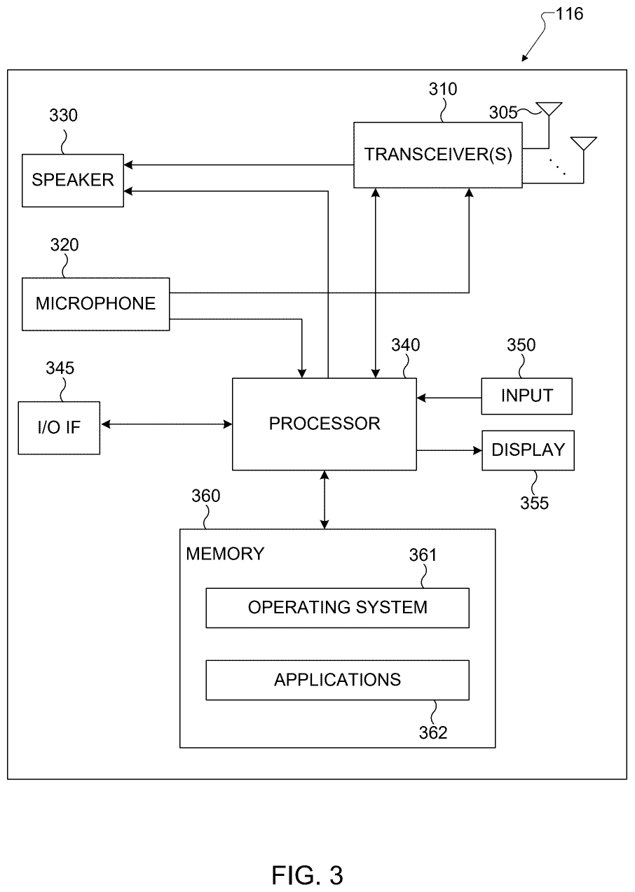

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support AI-based channel estimation in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

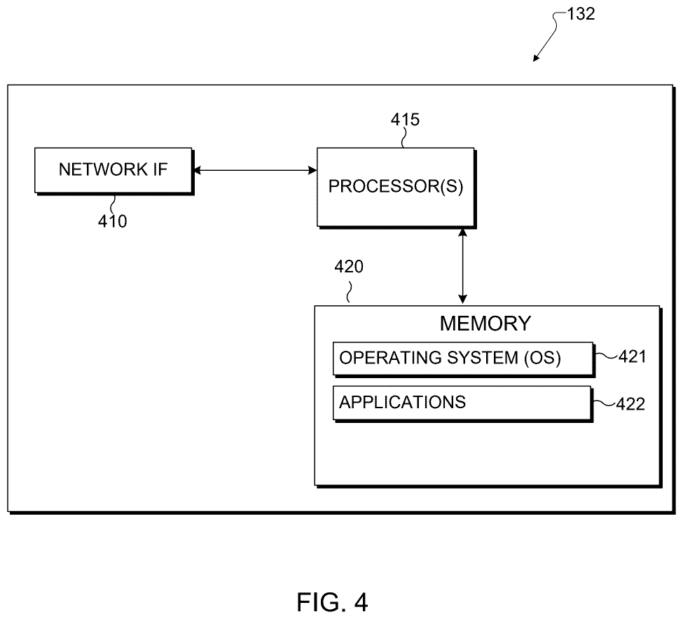

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources required for training the neural network.

The processor 415 is also capable of executing other processes and programs resident in the memory 420, such as operations that receive and store data. As described in greater detail below, the processor 415 may execute processes to train an AI model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

In modern wireless systems, such as those described regarding FIGS. 1-4, channel estimation (CE) plays a critical role in ensuring reliable and efficient communications in wireless communication systems, particularly in the scenarios in which the wireless channel conditions vary rapidly in an unpredictable manner. In practice, the channel estimation often relies on pilot signals, which are known symbols to a receiver and inserted into transmitted signals, allowing the receiver to measure the channel response at specific time, frequency, and/or spatial grids. The channel responses between pilot signals can be subsequently obtained using interpolation. Some CE solutions including the least squares (LS) based CE and the linear minimum mean square error (LMMSE) CE are based on predetermined signal models and are susceptible to modeling errors. Both of the LS-based solutions and the LMMSE-based CE solutions assume a linear model of the received signals corrupted by additive noise.

Recently, artificial intelligence (AI) techniques have been used to develop channel estimation solutions. The AI-based channel estimation solutions, in which an AI model can adapt and learn from the wireless channel's characteristics using a large amount of historical channel data, can achieve a superior estimation accuracy and robustness to modeling errors, varying channel conditions, and interferences. In particular, deep neural networks (DNNs), including convolutional neural networks (CNNs), recurrent neural networks (RNNs) and transformers (TFs), have been used to develop CE solutions for, e.g., denoising problems. These neural networks can learn complex relationships between the received signals and channel characteristics.

However, some AI-based CE solutions have been developed primarily for denoising natural images. Wireless channels are often highly sparse in the delay and/or angular domains. As a result, noisy images formed by an LS estimate of a channel matrix may exhibit a high sparsity in the delay and/or angular domains. Further, the delay and/or angular domain images differ considerably from their natural images. Some AI-based solutions have yet to effectively utilize such sparsity in a delay domain due in part to the increased compute complexity, thereby compromising the accuracy of the channel estimation.

The present disclosure describes an AI-based channel estimation method utilizing the sparsity in a transform domain (e.g., the delay and/or angular domains) while achieving a desirable performance-complexity tradeoff and significantly increasing the accuracy and reliability of the channel estimation in comparison to those of the other channel estimation models. Further, the present disclosure provides an AI architecture that provides denoising treatments tailored to the varying characteristics of the channel parts so as to reduce the computational complexity in the transform domain. In addition, the present disclosure improves the performance of the AI model by providing a mixed-SNR training based on improved one or more loss functions, leading to significant savings in the model storage and improving the in-field implementation of the AI model. Moreover, the AI-based channel estimation method according to the present disclosure employs additional physics informed features as the input to the AI model, thereby further improving the channel estimation accuracy.

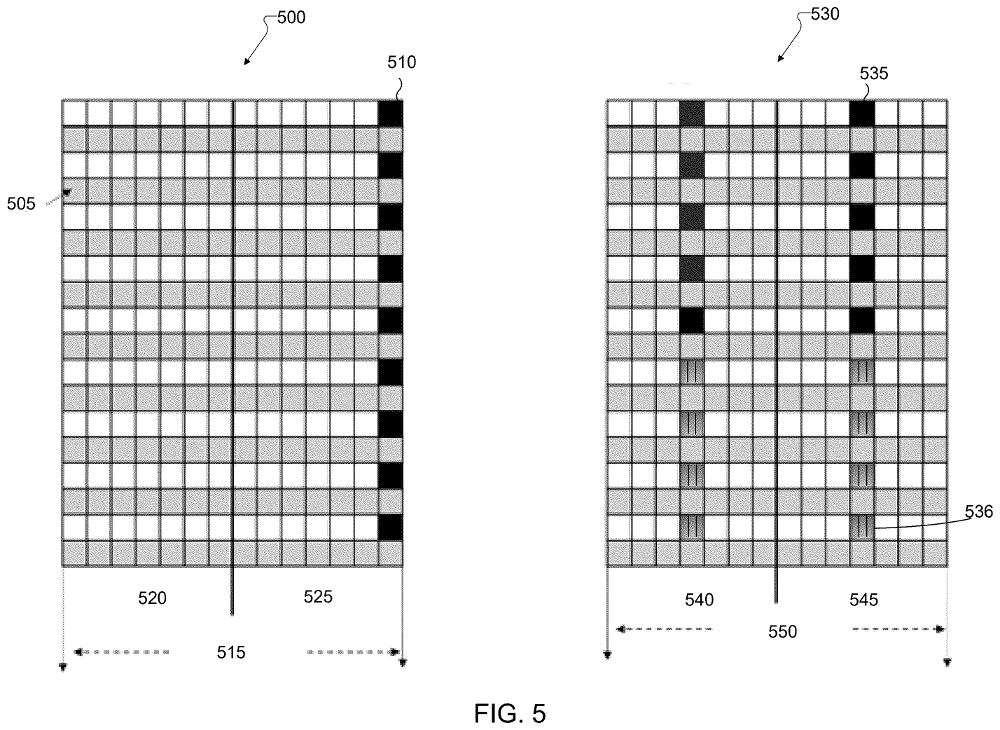

FIGS. 5-13 illustrate non-limiting embodiments of the AI-based channel estimation method, the resultant benefits, and related concepts thereof in greater detail in accordance with the present disclosure.

FIG. 5 illustrates example full bandwidths 500, 530 via which a sounding reference signal (SRS) 510 and physical uplink shared channel (PUSCH) demodulation reference signals (DMRS) 535 are transmitted in wireless communication systems, such as those described regarding FIGS. 1-4.

As illustrated in the example of FIG. 5, the SRS 510 and the PUSCH DMRSs 535 are transmitted in their corresponding allocated resource elements within the time-frequency grid having a number of resource elements (REs) 505. An RE may comprise one OFDM symbol period and one subcarrier, where the symbol period and subcarrier spacing are inversely related. In the full bandwidth (also referred to herein as the “band”) 500, the SRS 510 with a comb factor of 2 is being transmitted in the allotted OFDM symbols in the last slot 525 of the subframe 515. In the full band 530, the PUSCH DMRS 535 for one UE and the PUSCH DMRS 536 for another UE are being transmitted in their corresponding allotted OFDM symbols in the unlink slots 540,545 of the subframe 550.

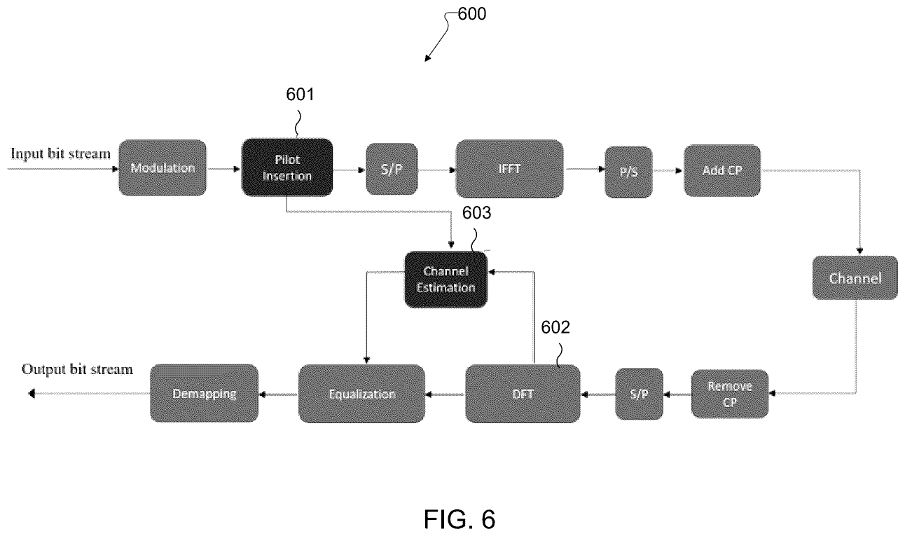

The SRS in the LTE/NR is a type of uplink pilot signals transmitted from a UE, which can be used by an eNodeB/gNodeB (e.g., a base station 101-103 of FIGS. 1 and 2) to estimate the uplink channel quality over a bandwidth of interests. The SRS-based channel estimation may be used to assist a base station uplink scheduler for the corresponding UE resource allocation and to improve downlink beamforming. The PUSCH DMRSs are another type of reference signals used for channel estimation and demodulation of uplink data, as illustrated further in detail with reference to FIG. 6.

FIG. 6 illustrates a diagram of an example cyclic prefix (CP)-orthogonal frequency division multiplexing (OFDM) uplink system 600 with a channel estimation module 603 according to embodiments of the present disclosure. FIG. 6 depicts the role of a channel estimation module 603 in uplink CP-OFDM-based PUSCH DMRS transmissions. It is noted that the same role may be applied to uplink discrete Fourier transform (DFT) spread OFDM (DFT-s-OFDM) transmissions as well.

As illustrated in the example of FIG. 6, the input bits may be first grouped and each group of the bits may be then mapped into a modulation symbol (e.g., a complex number). The output of the modulation module may be a stream of modulation symbols. Via operation 601, pilot signals (symbols) such as DMRS in time-frequency grids may be generated and positioned in the modulation symbol stream. After a series of operations, the output signals from a DFT module may be received signals Yₚ in the frequency-antenna (FA) domain via operation 702. The received signals Yₚ at the pilot tones in the FA domain along with known pilot signals indicated in operation 701 may be input to the channel estimation module 603.

The goal of the channel estimation is to estimate a channel matrix Hₚ based on a pilot signal Xₚ and a received signal Yₚ. The simplest channel estimation solution may be a least squares (LS) estimation. LS estimates of Hₚ, denoted as

$${\hat{H}}_{p}^{LS} ,$$

can be readily computed as:

$${[ {\hat{H}}_{p}^{LS} ]}_{i , j} = \frac{{[ {Y}_{p} ]}_{i , j}}{{[ {X}_{p} ]}_{i , j}}$$

where the subscript “i, j” denotes the (i, j)th entry of a channel matrix. Without a loss of generality, it can be assumed that the entries of Xₚ are equal to 1, and thus the LS estimates of Hₚ may be simply written as:

$${\hat{H}}_{p}^{LS} = {H}_{p} + {W}_{p}$$

where

$${\hat{H}}_{p}^{LS}$$

is a N_{pf}×Nₐₙₜ complex matrix. The real and imaginary parts of

$${\hat{H}}_{p}^{LS}$$

may be treated as noisy images and correspondingly the real and imaginary parts of Hₚ may be treated as noiseless images. Thus, the channel estimation may be formulated as an image denoising problem, where the inputs are noisy images (the real and imaginary parts of

$${\hat{H}}_{p}^{LS} )$$

and the outputs are denoised images (the real and imaginary part of estimated channels using AI models).

Mathematically, the input-output relationship between the transmitted and received signals at pilot tones in the frequency domain can be written as:

$${Y}_{p} = {H}_{p} ∘ {X}_{p} + {W}_{p} , \qquad Eq . ( l )$$

where Yₚ∈ [symbol] ^{N}^{_{pf}}^{×N}^{ₚₙ} is the received signals at pilot tones (subcarriers) across either the antennas or the time, Hₚ∈ [symbol] ^{N}^{_{pf}}^{×N}^{ₚₙ} denotes the channel matrix across either the antennas or the time (OFDM symbols), the operator ∘ represents the Hadamard product that is an element-wise product, Xₚ∈ [symbol] ^{N}^{_{pf}}^{×N}^{ₚₙ} is the transmitted pilot signals known to the receiver, and Wₚ∈ [symbol] ^{N}^{_{pf}}^{×N}^{ₚₙ} is an additive white Gaussian noise (AWGN). It is noted that in a single input multiple output (SIMO) uplink signal model, Nₚₙ can be used to represent the number of the received antennas while in a single input single output (SISO) case, Nₚₙ can be used to represent the number of the OFDM symbols containing pilot tones, respectively. Without a loss of generality, for the sake of notational simplicity, the present disclosure replaces Nₚₙ by Nₐₙₜ, which refers to the number of received antennas. Further, the AI-based channel estimation methods and apparatuses according to the present disclosure may also be applied to cases in which the pilot signals Xₚ have non-unit values.

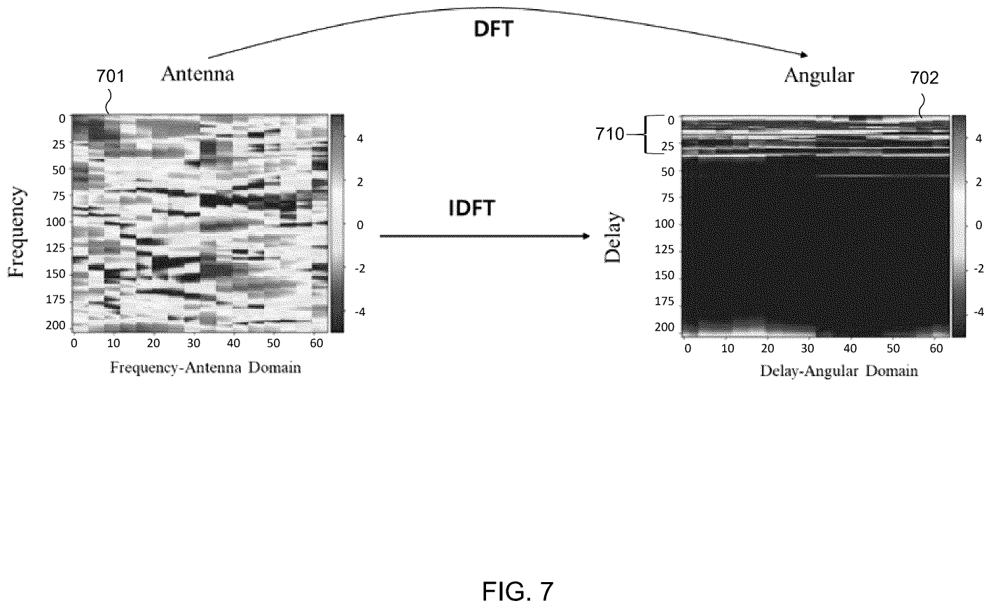

FIG. 7 illustrates an example noiseless image 701 being transformed into a delay domain according to embodiments of the present disclosure. In the example of FIG. 7, a perfect channel Hₚ (noiseless image) 701 in the FA domain may be transformed into its counterpart 702 in a delay-angular domain after a 1-D IDFT has been applied to the columns of Hₚ in the FA domain and then a DFT has been applied to the rows of the transformed Hₚ to the delay-angular domain. While FIG. 7 shows a perfect channel 701 having a magnitude of Hₚ (N_{pf}=288 and Nₐₙₜ=32), this is for illustrative purposes only, and thus any other signal with a different magnitude may be utilized for the AI-based channel estimation without departing from the scope of the present disclosure.

As can be seen from FIG. 7, in the delay-angular domain, the most useful information (e.g., channel state information (CSI) 710 may be concentrated at a small portion of the transformed image while the rest of the image may contain little or no useful information. In particular, the signal energy may be concentrated in a number of first time (delay) taps in a delay domain where the first time taps have a much higher signal to noise ratio (SNR) than the rest of the delay taps. This attribute renders the noisy images formed in a transform domain significantly different from the natural images as illustrated in FIG. 7

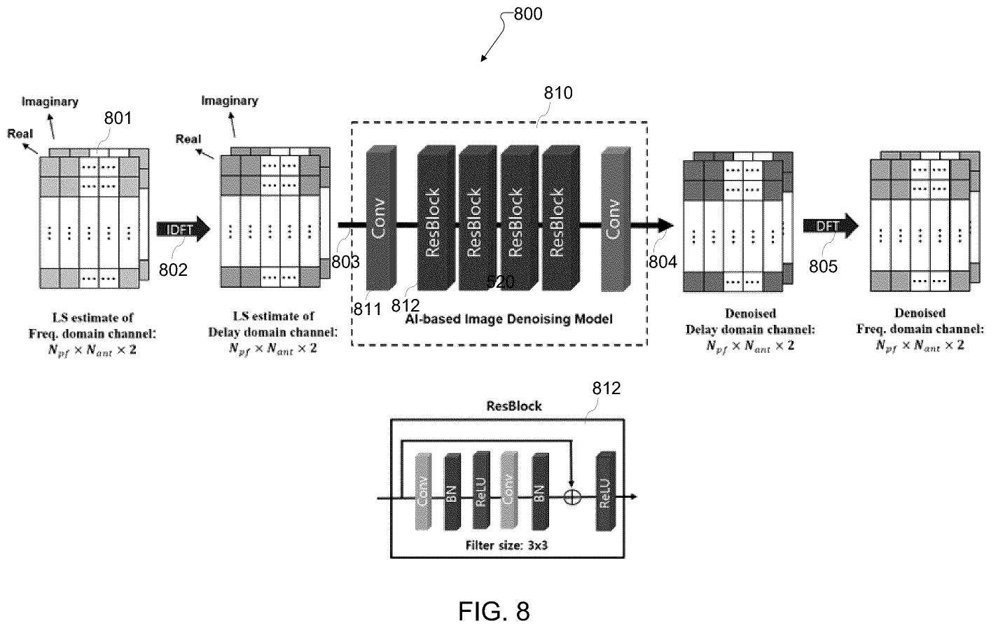

To appropriately deal with such a non-uniform and sparse feature of a delay domain image, the AI-based channel estimation method utilizes an AI model which includes residual learning networks (ResNets) for denoising in the delay domain as discussed further in detail with reference to FIGS. 8-13.

FIG. 8 illustrates a block diagram of an example AI-based channel estimation method 800 according to embodiments of the present disclosure. In the example of FIG. 8, the AI-based channel estimation method 800 may be performed by an electronic device (such as a base station 101-103 of FIGS. 1 and 2). The embodiment of the AI-based channel estimation method in FIG. 8 is for illustration only. Other embodiments of an AI-based channel estimation method may be used without departing from the scope of this disclosure. As illustrated in FIG. 8, the AI-based channel estimation method 800 begins at step 801.

At step 801, an electronic device (e.g., a base station 101-103) may obtain a least squares (LS) estimate

$${\hat{H}}_{p}^{LS}$$

of the noiseless channel matrix Hₚ from the received signal Yₚ. The LS estimate

$${\hat{H}}_{p}^{LS}$$

may be treated as a noisy channel image (also referred to herein as a noisy image or a noisy channel) having a size of N_{pf}×Nₐₙₜ×2 in the frequency-antenna (FA) domain. The term “2” refers to the real and imaginary parts of the wireless channels.

At step 802, a noisy image(s)

$${\hat{H}}_{p}^{LS}$$

in the FA domain may be first converted (transformed) into a delay, delay-antenna, or delay-angular domain noisy image(s). In transforming the noisy image

$${\hat{H}}_{p}^{LS} ,$$

one dimensional (1-D) and/or a two-dimensional (2-D) domain transform may be utilized. For the 1-D transform, typically a 1-D inverse discrete Fourier transform (IDFT) or other transforms may be applied to the LS estimate

$${\hat{H}}_{p}^{LS}$$

antenna by antenna. For the 2-D transform, a 2-D IDFT or other 2-D transforms such as a wavelet transform may be applied to the LS estimate

$${\hat{H}}_{p}^{LS}$$

simultaneously across the frequencies and antennas. For example, and without limitation, the following transforms may be performed:
1. first apply a 1-D transform (e.g., a 1-D IDFT or a 1-D inverse wavelet transform) to the columns (frequencies) of

$${\hat{H}}_{p}^{LS}$$

and then apply a 1-D transform (e.g. a 1-D DFT or a 1-D wavelet transform) to the rows (antennas) of

$${\hat{H}}_{p}^{LS} ,$$

or vice visa;
2. apply a 2-D transform (e.g., a 2-IDFT or a 2-D wavelet transform) directly to

$${\hat{H}}_{p}^{LS} ;$$

3. first apply a 1-D transform (e.g., a 1-D IDFT or a 1-D inverse wavelet transform) to the columns (frequencies) of

$${\hat{H}}_{p}^{LS} ,$$

and then apply a 1-D transform to each antenna polarization of the 1-D shape separately, and concatenate two transformed vectors into a single long vector;
4. first apply a 1-D transform (e.g., a 1-D IDFT or 1-D inverse wavelet transform) to the columns of

$${\hat{H}}_{p}^{LS}$$

(frequencies), and then apply a 2-D transform to each antenna polarization of 2-D shape separately and concatenate two transformed vectors into a single long vector; or
5. only apply a 1-D transform (e.g., a 1-D IDFT or a 1-D inverse wavelet transform) to the columns (frequencies) of

$${\hat{H}}_{p}^{LS}$$

without applying a transform to the rows (antennas) of

$${\hat{H}}_{p}^{LS} .$$

The aforementioned joint denoising across frequency/space domains or corresponding transformed domains capitalizes on the fact that the nearby channels (REs) in the frequency and/or spatial domains may be highly correlated, similar to closely placed pixels being related to one another (‘locality’) in a natural image, and thus the features of an image in the transformed or latent spaces can be efficiently used for denoising, rendering the learning effective feature representations of a channel in the transformed or latent spaces important to the denoising operation. In some examples, considering the difficulties in obtaining accurate second order of statistics of a channel, particularly in non-stationary channel conditions, the inversion of large matrices, e.g., frequent updates of covariance matrices of size 288×32=9216 in non-stationary channels, may be utilized to reduce the high complexity for the joint denoising across the frequency/space domains.

At step 803, the transformed noisy images may be input to an image denoising model 810. The image denoising model 810 may include two convolutional layers 811 and a number of residual learning networks (ResNets) 812. While FIG. 8 shows image denoising model 810 including 4 ResNets (also referred to herein as “ResNet blocks”), this is for illustrative purposes only, and thus the image denoising model 810 may include any other number of ResNet blocks as appropriate without departing from the scope of the present disclosure. Each ResNet block 812 may include two batch normalization (BN) layers, two convolutional layers, and an ReLU layer between the BN layers and the convolutional layers. It may also include another ReLU layer after the skip connection.

At step 804, the image denoising model 810 outputs denoised image of the noisy image in the delay-antenna or delay-angular domain. At step 805, the denoised image in the delay-antenna or delay-angular domain may be transformed (by a DFT) back into the FA domain, i.e., the same domain of the original input

$${\hat{H}}_{p}^{LS} .$$

In the present disclosure, it is assumed that ‘genie’ channel data may be collected as the labelled data and the image denoising model 810 may be trained in a supervised learning manner. In practice, it may be difficult or even infeasible to obtain the ‘genie’ channel data from the field. In such a case, the ‘genie’ channel data may be replaced by a high SNR data as noisy labels for training the image denoising model 810.

In the frequency domain, channels at pilot REs may have a strong long-range correlation based on delay spreads of the channels while in the antenna domain, an antenna correlation may have a long-range correlation based on multiple factors such as an antenna placement, antenna spacing, and/or antenna type. To capture the relative long-range dependency in the FA domain, neural network (NN)-based denoising models need to enlarge an effective receptive field by increasing the depth or stride of the neural networks. Increasing the depth or stride of the neural networks, nevertheless, may result in an increased complexity or a performance degradation.

As mentioned previously, in a transform domain the most dominant CSI is typically concentrated on a number of the first consecutive taps or nearby angles of arrival. Such channel sparsity in a transform domain indicates that a receptive field in a transform domain required for denoising can actually be much smaller than the receptive field in the FA domain. It has been shown that by exploiting the channel sparsity in a transform domain, the AI-based CE method 800 with 4 ResNet blocks in the delay-antenna domain can achieve substantially the same estimation accuracy to the one with 32 ResNet blocks in the frequency-antenna domain in a single input single output (SISO) single user setting. Similarly, it has also been shown that in a single input multiple output (SIMO) two user setting (e.g., with multi-user interference (MUI)), the AI-based channel estimation method 800 utilizing 4 ResNet blocks in the delay-antenna domain can outperform a CE solution having the ResNets blocks in the frequency-antenna domain by about 4 dB at SNR=0 dB in terms of the ideal normalized mean square error (NMSE) performance property.

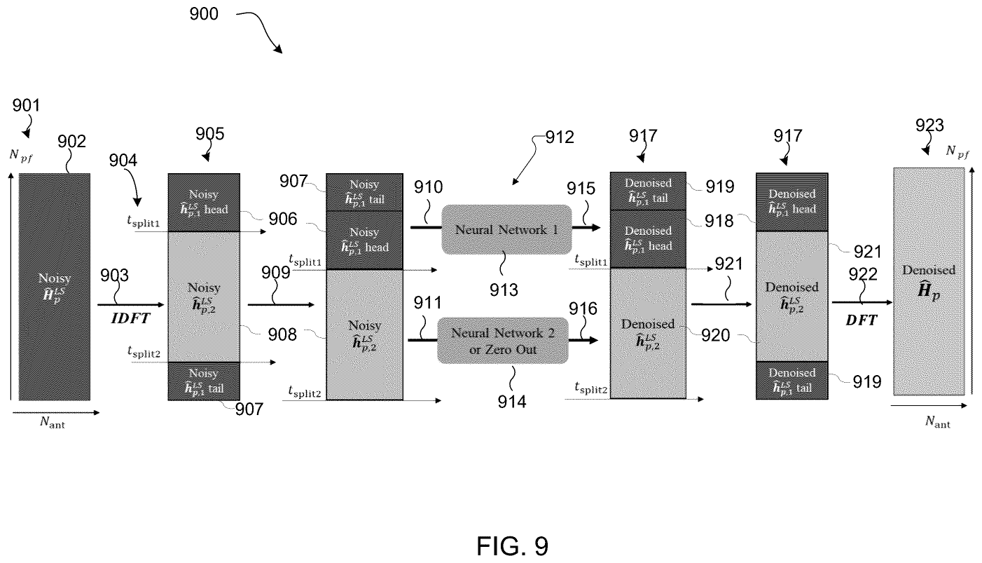

FIG. 9 illustrates an example AI-based channel estimation method 900 according to embodiments of the present disclosure. The embodiment of the AI-based channel estimation method in FIG. 9 is for illustration only. Other embodiments of the AI-based channel estimation method may be used without departing from the scope of this disclosure. In the example of FIG. 9, the AI-based channel estimation method 900 may be performed by an electronic device (such as a base station 101-103 of FIGS. 1 and 2). The method 900 utilizes an image denoising model 910 that is similar to the image denoising model 810 of FIG. 8, but differs in that the ResNets may perform channel estimation based on the split-transformed noisy image and that the image denoising model 910 itself may be split into two different networks to apply differentiated treatments according to the differing characteristics of corresponding split parts.

As mentioned previously, in a transform domain, only a small part of the noisy image (either real or imaginary part of

$${\hat{H}}_{p}^{LS} )$$

contains the most dominant CSI while the other part of the noisy image (either real and imaginary part of

$${\hat{H}}_{p}^{LS} )$$

only contains mostly the noise due to the sparse nature of wireless channels. Capitalizing on this property, the AI-based channel estimation method 900 may first split the noisy image (either real or imaginary part of

$${\hat{H}}_{p}^{L S} )$$

into multiple parts depending on how useful CSI are distributed in an image, and each part can be learned using different AI models with different complexities as described in a greater detail below.

The AI-based channel estimation method 900 begins at step 901. At step 901, an electronic device (e.g., a base station 101-103 of FIGS. 1 and 2) may obtain a noisy image (either real or imaginary part of

$${\hat{H}}_{p}^{L S} )$$

902 in the frequency domain. In the example as illustrated in FIG. 9, the noisy image 902 may represent a least squares (LS) estimate of the noiseless channel matrix Hₚ, where channel state information (CSI) is distributed densely with little sparsity. The noisy image 902 may be real or imaginary parts thereof. At step 903, the noisy image (either real or imaginary part of

$${\hat{H}}_{p}^{L S} )$$

902 in the frequency domain (e.g., two convolutional channels, the real and imaginary parts of

$${\hat{H}}_{p}^{L S} )$$

may be converted to its counterpart

$${\hat{h}}_{p}^{L S}$$

in a transform domain via the IDFT.

At step 904, the transformed noisy image (either real or imaginary part of

$${\hat{h}}_{p}^{L S}$$

905 may be split into two parts, a first part

$${\hat{h}}_{p , 1}^{L S}$$

containing the dense CSI and a second part

$${\hat{h}}_{p , 2}^{L S}$$

908 containing mostly the noise. Upon splitting, either of these parts in the transformed noisy image 905 may not be contiguous. For example, due to the IDFT wrapping around effects, the first part

$${\hat{h}}_{p , 1}^{L S}$$

with the dense CSI may contain a top portion

$${\hat{h}}_{p , 1}^{L S}$$

906 and a bottom portion

$${\hat{h}}_{p , 1}^{L S}$$

907 as shown in FIG. 9. Thus, the transformed image 905 within [0, tₛₚₗᵢₜ_{₁}]×[1, Nₐₙₜ] and [tₛₚₗᵢₜ_{₂}, N_{pf}]×[1, Nₐₙₜ] may contain the dense CSI while the transformed image within [tₛₚₗᵢₜ_{₁}+1, tₛₚₗᵢₜ_{₂}−1]×[1, Nₐₙₜ] may contain mostly the noise. The values of tₛₚₗᵢₜ₁ and tₛₚₗᵢₜ₂ may be determined to ensure that the dominant parts of the channel energy

$$( e . g . , {\sum }_{i = 1}^{{N}_{a n t}} \vert {h}_{delay , i} {\vert}^{2} )$$

are kept in the intervals of [0, tₛₚₗᵢₜ_{₁}] and [tₛₚₗᵢₜ_{₂}, N_{pf}]. For example, the values of tₛₚₗᵢₜ₁ and tₛₚₗᵢₜ₂ may be selected such that 95% of the channel energy is kept in the intervals of [0, tₛₚₗᵢₜ_{₁}] and [tₛₚₗᵢₜ_{₂}, N_{pf}].

At step 909, the bottom portion

$${\hat{h}}_{p , 1}^{L S}$$

907 may be moved above the top portion

$${\hat{h}}_{p , 1}^{L S}$$

906 such that the bottom portion 907 and the top portion 906 are contiguous. The split transformed image may then be input to an image denoising model 912 including a first neural network 913 and a second neural network 14. At step 910, the first part

$${\hat{h}}_{p , 1}^{L S}$$

of the noisy image 905 with the dense CSI may pass through the first neural network 913. At step 911, the second part

$${\hat{h}}_{p , 2}^{LS}$$

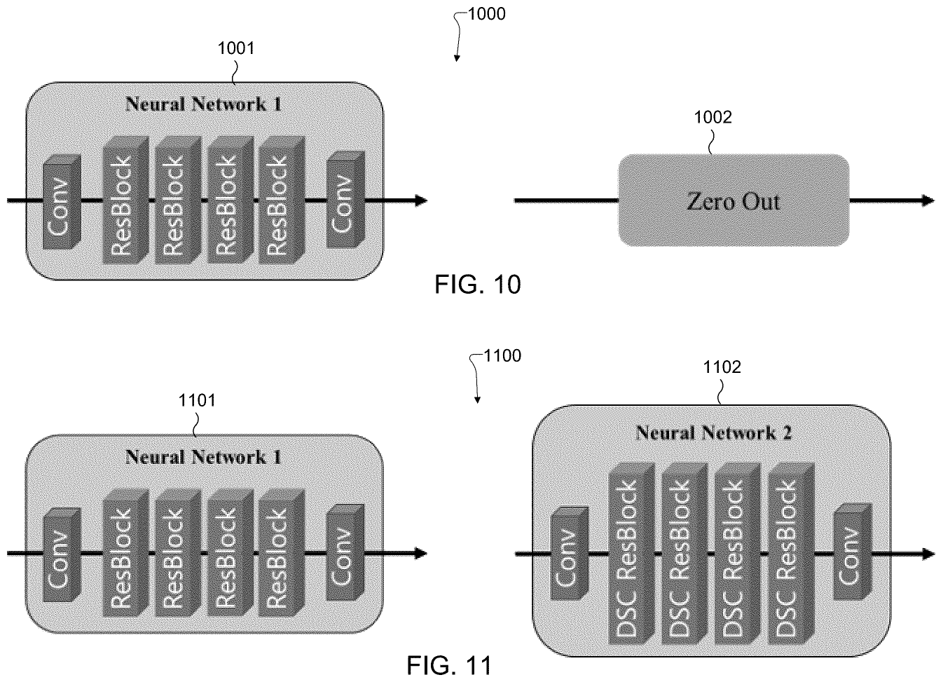

908 with mostly the noise may pass through the second neural network (or zero out) 914. The first and second neural networks 913, 914 can be treated as a special type of neural networks. Depending on the design objectives, different neural network architectures may be selected to denoise different parts of a noisy image. Exemplary image noising models according to the present disclosure are discussed further in detail with reference to FIGS. 10 and 11.

At step 915, the first neural network 913 may output the denoised first part

$${\hat{h}}_{p , 1}^{LS} ,$$

and at step 916, the second neural network 914 may output the denoised second part

$${\hat{h}}_{p , 2}^{LS}$$

920. The denoised first part

$${\hat{h}}_{p , 1}^{LS}$$

includes the denoised top portion 918 and the denoised bottom portion 919 disposed above the denoised top portion 918. At step 917, the denoised first and second parts may be concatenated into a denoised transformed image of the original input size. At step 921, the denoised bottom portion 919 of the denoised first part

$${\hat{h}}_{p , 1}^{LS}$$

may be moved below the denoised second part

$${\hat{h}}_{p , 2}^{LS}$$

920. At step 922, the denoised transformed image in the transform domain may be converted back into its counterpart 923 in the original domain (the frequency domain) via the DFT.

FIGS. 10 and 11 illustrate example image denoising models (hereinafter, also referred to as a split-ResNet based CE model) 1000 and 1100 according to embodiments of the present disclosure. The embodiments of the image denoising model in FIGS. 10 and 11 are for illustration only. Other embodiments of an AI-based image denoising model may be used without departing from the scope of this disclosure.

As illustrated in the example of FIG. 10, the split-ResNet based CE model 1000 may include a first neural network 1001 and a second neural network 1002. The first neural network 1001 may be a ResNet neural network using the standard 2-D convolutions. The second neural network 1002, however, may perform zero-out function and be treated as a neural network with all zero weights. In practice, typically 50% of the noisy image contains the dense CSI and the other 50% contains mostly the noise. As illustrated in FIG. 10, the size of the noisy image that needs to be denoised by the image denoising model 1000 may be significantly reduced upon splitting the dense CSI part and the noisy part. Accordingly, the computational complexity of the image denoising model 1000 may be significantly lower than a baseline ResNet-based CE model as illustrated in Table 1.

Table 1 below indicates that the Split ResNet-based CE Model 1000 may reduce the computational complexity by approximately 50% with only a marginal performance degradation as compared to baseline ResNet-based CE models.

TABLE 1

| Models/ | Baseline ResNet-based | Split ResNet-based CE |
|---|---|---|
| Complexity | CE Model | Model 1000 |
| Floating point operations | 509.7M | 249.9M |
| [25 MHz, 64 Rx] per UE | | |
| Complexity Reduction | NA | 51% |
| percentage | | |

Complexity: A Baseline ResNet-based CE Model v. Image Denoising Model 1100.

As illustrated in the example of FIG. 11, the split-ResNet based CE model) 1100 may include a ResNet using the standard 2-D convolution as a first neural network 1101 and a ResNet using a depth-wise separable convolution as a second neural network 1102. The depth-wise separable convolution (DSC) may be an essential enabling technique utilized for a lightweight neural network architecture for mobile and embedded vision applications. The DSC may split a standard 2-D convolution into two steps: a depth-wise convolution step and a point-wise convolution step. Compared with the standard 2-D convolution, the DSC may have fewer parameters and a lower computational complexity while possibly reducing representation power and model generalization capacity.

The part

$${\hat{h}}_{p , 1}^{LS}$$

of a noisy image, which contains dense CSI, may be input to the first neural network 1101 that may be relatively more complex and have a stronger model generalization capacity as compared to the second neural network 1102. The part

$${\hat{h}}_{p , 2}^{LS}$$

of the noisy image, which contains mostly the noise, may be input to the second neural network 1102 that may be relatively simpler and have a weaker model generalization capacity as compared to the first neural network 1101.

It is noted that as compared to a baseline ResNet-based CE model, the split ResNet-based CE model 1100 may have a lower computational complexity. Further, the split ResNet-based CE model 1100 may have more learnable parameters due to the fact that it has additional DSC blocks to process the part of the noisy image containing mostly the noise. In addition, it has been shown that both of the split-ResNet based CE models 1000 and 1100 can outperform the baseline moving average (MA) models significantly.

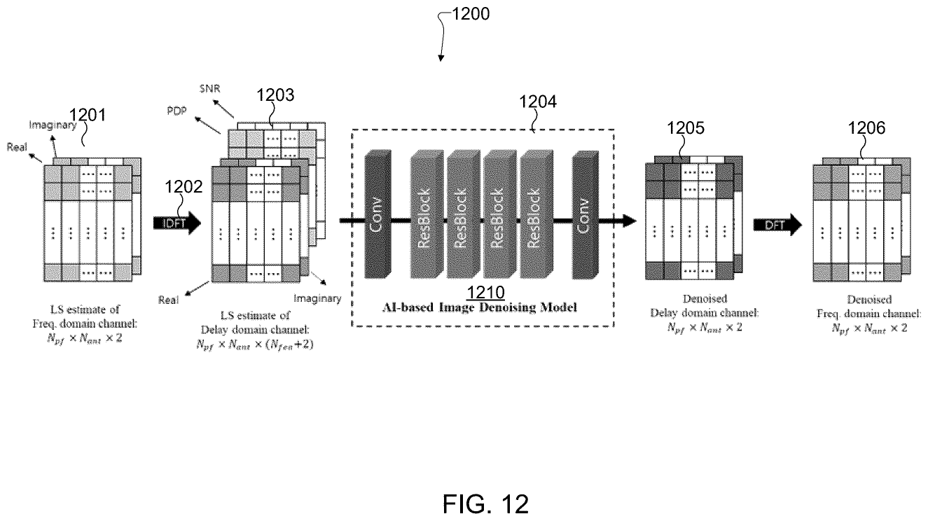

FIG. 12 illustrates an example AI-based channel estimation method 1200 according to embodiments of the present disclosure. The embodiment of the AI-based channel estimation method in FIG. 12 is for illustration only. Other embodiments of an AI-based channel estimation method may be used without departing from the scope of this disclosure. In the example of FIG. 12, the AI-based channel estimation method 1200 may be performed by an electronic device (such as a base station 101-103 of FIGS. 1 and 2).

As illustrated in the example of FIG. 12, the method 1200 begins at step 1201. At step 1201, an electronic device (a base station 101-103 of FIGS. 1 and 2) may obtain a noisy image representing a least squares estimate of a channel matrix. At step 1202, the noisy image may be transformed into a delay domain. At step 1204, the transformed noisy image (the real and imaginary parts) 1203 may be input to the image denoising model 1210.

In addition to the noisy image, certain side information or additional features such as power delay profiles (PDPs), and/or SNR may be provided as additional inputs to the image denoising model 1210 for performance improvement and/or complexity reduction of the model 1210. The PDP and SNR are important features of wireless channels. A PDP represents the average power of the received signals through a multipath channel as a function of time delay. Providing the PDP and/or SNR features as the additional input to the image denoising model 1210 may facilitate the model 1210 to improve data representation learning. Thus, as depicted in FIG. 12, at step 1203 a PDP and/or SNR feature may be added to the input to the image denoising model 1210 as two more channels along with real and imaginary parts of the noisy image.

To calculate a PDP, a sequence of the frequency-domain channel vectors at the pilot tones of the ith receive antenna over L SRS symbols, namely,

$${h}_{l , i}^{( f )}$$

is collected, where

$${h}_{l , i}^{( f )}$$

is a vector of length N_{pf}, i=1, . . . , Nₐₙₜ, and l=1, . . . , L, with the superscript (f) indicating frequency domain channels. The PDP at the received antenna is calculated as follows:

$${h}_{i}^{PDP} = \frac{1}{L} {\sum }_{l = 1}^{L} ( {W}^{H} {h}_{l , i}^{( f )} ) ∘ {( {Wh}_{l , i}^{( f )} )}^{H} , i = 1 , … , {N}_{ant}$$

where

$${h}_{i}^{PDP}$$

is a PDP vector of size N_{pf} at the ith receive antenna, ∘ denotes the Hadamard product (elementwise product), and W denotes a DFT matrix.

After collecting data samples from all of the Nₐₙₜ antennas, an N_{pf}×Nₐₙₜ PDP feature map may be formed and added as an input convolutional layer to the image denoising model 1210. Likewise, an N_{pf}×Nₐₙₜ SNR feature map may be formed, in which each element represents the average SNR value at the ith receive antenna and the kth delay tap with i∈[1, Nₐₙₜ] and k∈[1, N_{pf}]. It has been observed that a ResNet based image denoising model 1210 using a PDP as an additional input can improve the NMSE performance over 1 dB at SNR=0 dB as compared to a ResNet that does not utilize a PDP as an input in a SISO case. It is noted that under a different underlying system assumption, the PDP and SNR can be calculated differently.

In addition to the aforementioned significant improvements in CE performance, the present disclosure provides further and/or alternative enhancements to the AI-aided channel estimation method 800, 900, 1000, 1100, and 1200. In one embodiment, the image denoising model (also referred to the AI model or the AI CE model) 810, 912, 1000, 1100, 1210 may undergo a mixed signal to noise ratio (SNR) training utilizing novel loss functions according to the present disclosure. The training of the AI CE models may be performed by a network device (e.g., without limitation, a network server 132 of FIGS. 1 and 4) or a remote training server.

In general, a training data contains data samples with various SNR values. Data samples with different SNRs may exhibit large discrepancies in terms of the data distribution. Depending on how the data samples with different SNR values are used in training a model, there are two possible methods to obtain training models for CE: the per SNR training and the mixed SNR training. In the per SNR training, an SNR specific trained model only using the training data at a specific SNR may be selected. In this case, there may be multiple trained models, each corresponding to a given SNR. In the inference phase of the per SNR training, an SNR value for testing samples is first estimated and the trained model corresponding to this SNR value is used to perform inference. The advantage of the per SNR training is that it typically can achieve an excellent channel estimation accuracy if the number of the data samples is sufficient. However, there are two major drawbacks to the per SNR training. The first drawback is that in the per SNR training, multiple inference models need to be generated, each model for a given SNR. The second drawback is that in the per SNR training, an SNR estimation is important, and the accuracy of SNR estimation may be important for selecting a correct inference model. However, estimating SNR accurately can be challenging in practice.

The mixed SNR training may be a viable option that can naturally overcome these two drawbacks. Nonetheless, it has been shown that the mixed SNR training suffers a significant performance degradation at a high SNR in the angular-delay domain and the spatial-frequency domain if the mixed SNR training is applied directly without making any other changes to the ‘vanilla’ solutions.

Various loss functions include unweighted loss functions such as:
i. Mean squared error (MSE) loss:

$${Loss}_{MSE} = \frac{1}{N} {\sum }_{i = 0}^{N} {‖ {H}_{p , true}^{i} - {H}_{p , pred}^{i} ‖}^{2} , \qquad Eq . ( MSE )$$

ii. L2 loss:

$${Loss}_{{L}_{2}} = \sqrt{\frac{1}{N} {\sum }_{i = 0}^{N} {‖ {H}_{p , true}^{i} - {H}_{p , pred}^{i} ‖}^{2}} ,$$

iii. Normalized mean squared error (NMSE) loss:

$${Loss}_{NMSE} = \frac{{\sum }_{i = 0}^{N} {‖ {H}_{p , true}^{i} - {H}_{p , pred}^{i} ‖}^{2}}{{\sum }_{i = 0}^{N} {‖ {H}_{p , true}^{i} ‖}^{2}} ,$$

iv. Mean absolute error (MAE):

$${Loss}_{MAE} = \frac{1}{N} {\sum }_{i = 0}^{N} ‖ {H}_{p , true}^{i} - {H}_{p , pred}^{i} ‖ ,$$

where N denotes the number of data samples,

$${H}_{p , true}^{i}$$

denotes the true channel (ground truth) of the ith data sample at pilot tones, and

$${H}_{p , true}^{i}$$

denotes the predicted channel of the ith data sample at pilot tones. However, the issue for unweighted loss functions in the mixed SNR training is that there is a large performance degradation at high SNRs because the original loss function (either the MSE or the NMSE) is dominantly impacted by the errors at low SNRs, and thus model parameters determined by using stochastic gradient decent (SGD) favor to minimize the losses at low SNRs instead of ones at high SNRs.

The following SNR weighted loss function purports to overcome this performance degradation issue by using a weighted loss function based on SNR values as defined as follows:

$$New Loss = {\sum }_{i} \frac{{Loss}_{unweighted , {SNR}_{i}}}{{10}^{- {SNR}_{i}}} \qquad Eq . ( 2 )$$

where SNRᵢ denotes the ith SNR value in dB and Loss_{unweighted,SNR}_{ᵢ} denotes the converged unweighted training or validation loss (e.g. MSE or NMSE loss) at SNRᵢ during the per SNR training. In this SNR weighted loss function (Eq. 2), the weights are selected to a function of SNR values. The SNR weighted loss function attempts to balance losses for different SNRs in the sense that the loss at a higher SNR will be weighted more such that model parameters determined by using SGD will balance the loss minimization across various SNR values. However, the weight of each loss term is given by 10^{SNR}^{ᵢ} where SNRᵢ is given in the dB scale, and thus in order to balance loss terms at different SNR values, the actual weights of the loss terms should be dependent on the unweighted loss calculated using training or validation data samples instead of depending solely on the SNR values.

The example embodiments of the present disclosure provide two alternative weighted losses functions, each having advantages over the aforementioned net loss functions. In one example embodiment, a first alternative weighted loss function (Lossₐₗₜₑᵣ₁) may be provided to overcome the issues with the SNR weighted loss function (Eq. 2) as follows:

$${Loss}_{alter 1} = {\sum }_{i} \frac{{Loss}_{unweighted , {SNR}_{i}}}{f ( {Loss}_{unweighted , {SNR}_{i}} )} \qquad Eq . ( 3 )$$

where the weights are selected to be an inverse of the function of Loss_{unweighted,SNR}_{ᵢ}. For example, if Loss_{unweighted,SNR}_{ᵢ} is selected to the unweighted MSE loss (defined by Eq. (MSE) above) that is evaluated at SNRᵢ, the weight at SNRᵢ can be selected to be Loss_{unweighted,SNR}_{ᵢ} or a linear function of LOSS_{unweighted,SNR}_{ᵢ}. In the first alternative loss function, a per SNR model may need to be trained first to obtain unweighted losses at SNRᵢ, and then the loss specified in Eq. (3) may be utilized to retrain the model. Thus, in order to obtain an inference model, the AI CE model may need to be trained twice for two different loss functions.

Alternatively, a hybrid loss function (also referred to herein as a second alternative loss function Lossₐₗₜₑᵣ₂) according to the present disclosure is provided. The hybrid loss function may avoid performing training twice using two different loss functions while it may also consider the loss discrepancies at different SNR values. The hybrid loss function may be provided as follows:

$${Loss}_{alter 2} = \{ \begin{matrix}{Loss}_{MSE} & if SNR < 0 \\ {Loss}_{{L}_{2}} & if SNR \geq 0\end{matrix} .$$

if the loss function values across all SNRs of the interests are less than 1. Since the loss function values are less than 1, using Loss_{L}_{₂} (which is a square root of Loss_{MSE}) may lead to a larger loss as compared to using LOSS_{MSE} for the SNRs greater than 0, and vice visa. If the loss function values across all of the SNRs of the interests are greater than 1, the hybrid loss function may be changed to:

$${Loss}_{alter 2} = \{ \begin{matrix}{Loss}_{{L}_{2}} & if SNR < 0 \\ {Loss}_{MSE} & if SNR \geq 0\end{matrix} .$$

Table 2 below depicts the NMSE performance comparisons between the mixed SNR training and the per SNR training with different loss functions over Tapped Delay Line (TDL)-A, -B, -C, Clustered Delay Line (CDL)-C, and Urban Micro (UMi) channels for SNRs ranging between −10 dB to 15 dB. As can be seen from Table 2, compared to the NMSE performance of the per SNR training models obtained by using the unweighted MSE loss function, the mixed SNR training models obtained by using the same unweighted MSE loss suffer significant testing performance degradations across all of the five channel profiles. The average maximum gap between the mixed SNR training and the per SNR training across TDL-A, -B, -C, CDL-C, and UMi channels is 2.18 dB for SNRs ranging from −10 dB to 15 dB. By using the SNR weighted loss function (EQ. 2) or the hybrid loss function, the average maximum gap can be reduced from 2.18 dB to 0.81 dB or 0.82 dB, respectively. Furthermore, compared to using the SNR weighted loss function or the hybrid loss function Lossₐₗₜₑᵣ₂, using the first alternative loss function Lossₐₗₜₑᵣ₁ (EQ. 3) can further reduce the average maximum gap from 0.81 dB to 0.49 dB. As compared to the SNR weighted loss function, the hybrid loss function may perform very similarly in terms of the average maximum gap across the five different channel profiles (0.82 dB vs 0.81 dB). Furthermore, the hybrid loss function may have a much less stringent requirement on the SNR estimation accuracy than the SNR weighted loss function (EQ. 2). As can be seen from Table 2, the first and second alternative loss functions Lossₐₗₜₑᵣ₁, LOSSₐₗₜₑᵣ₂ may provide a comparable or better NMSE performance improvement as compared to the other solutions including the SNR weighted loss function (EQ. 2).

TABLE 2

| Loss | Channel | Gaps from Per SNR Models |
|---|---|---|
| functions | Types | Max Gap Value [dB] |
| Unweighted MSE (EQ. | TDL-A | 3.27 |
| (MSE)) | TDL-B | 1.01 |
| | TDL-C | 1.31 |
| | CDL-C | 3.43 |
| | UMi | 1.88 |
| SNR Weighted Loss | TDL-A | 0.48 |
| Function (EQ. 2) | TDL-B | 0.75 |
| | TDL-C | 0.90 |
| | CDL-C | 1.41 |
| | UMi | 0.49 |
| First Alternative Loss | TDL-A | 0.69 |
| Function (Lossₐₗₜₑᵣ₁) | TDL-B | 0.32 |
| | TDL-C | 0.34 |
| | CDL-C | 0.80 |
| | UMi | 0.31 |
| Second Alternative Loss | TDL-A | 1.06 |
| Function (Lossₐₗₜₑᵣ₂) | TDL-B | 0.46 |
| | TDL-C | 0.52 |
| | CDL-C | 1.27 |
| | UMi | 0.81 |

Performance Gaps between Mixed SNR Training and Per SNR Training for Different Loss Functions

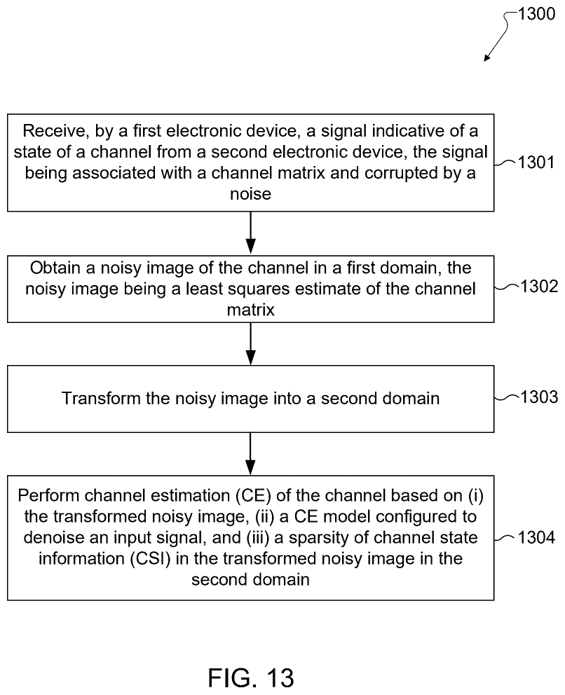

FIG. 13 illustrates a flow chart for an AI-based channel estimation method 1300 according to embodiments of the present disclosure The embodiment of the AI-based channel estimation method in FIG. 13 is for illustration only. Other embodiments of an AI-based channel estimation method may be used without departing from the scope of this disclosure. In the example of FIG. 13, the AI-based channel estimation method 1300 may be performed by an electronic device (such as a base station 101-103 of FIGS. 1 and 2).

In the example of FIG. 13, the method 1300 begins at step 1301. At step 1301, a first electronic device (e.g., a base station 101-103 of FIGS. 1 and 2) may receive a signal indicative of a state of a channel from a second electronic device (e.g., a UE 111-116 of FIGS. 1 and 3). At step 1302, the first electronic device may obtain a noisy image of the channel in a first domain. The noisy image may be a least squares estimate of the channel matrix. At step 1303, the first electronic device may transform the noisy image into a second domain. At step 1304, the first electronic device may perform channel estimation (CE) of the channel based on (i) the transformed noisy image, (ii) a CE model configured to denoise an input signal, and (iii) a sparsity of channel state information (CSI) in the transformed noisy image in the second domain.

In one embodiment, the CE model may include a first neural network including residual learning networks (ResNets) configured to utilize a two-dimensional convolution and a second neural network configured to perform a zero-out function. Performing the CE of the channel may include splitting the transformed noisy image into a first part including the CSI and a second part including the noise. The first part may include a top portion of the transformed noisy image and a bottom portion of the transformed noisy image, and the second part may be disposed between the top and bottom portions. Performing the CE of the channel may further include moving the bottom portion to the top portion such that the top and bottom portions are contiguous; inputting the first part into the first neural network and the second part into the second neural network; denoising, by the first neural network, the first part; denoising, by the second neural network, the second part; concatenating the denoised first part and the denoised second part into a denoised image having an original size of the transformed noisy image; moving the denoised bottom portion of the denoised image below the denoised second portion of the denoised image; and de-transforming the denoised image into the first domain.

In one embodiment, the CE model may include a first neural network including residual learning networks (ResNets) configured to utilize a two-dimensional convolution and a second neural network including ResNets configured to utilize a depth-wise separable convolution that includes a depth-wise convolution and a point-wise convolution. Performing the CE of the channel may include splitting the transformed noisy image into a first part including the CSI and a second part including the noise. The first part may include a top portion of the transformed noisy image and a bottom portion of the transformed noisy image, and the second part may be disposed between the top and bottom portions. Performing the CE of the channel may further include moving the bottom portion to the top portion such that the top and bottom portions are contiguous; inputting the first part into the first neural network and the second part into the second neural network; denoising, by the first neural network, the first part; denoising, by the second neural network, the second part; concatenating the denoised first part and the denoised second part into a denoised image having an original size of the transformed noisy image; moving the denoised bottom portion of the denoised image below the denoised second portion of the denoised image; and de-transforming the denoised image into the first domain.

In one embodiment, the CE model may be trained based on a per signal to noise ratio (SNR) training algorithm to obtain unweighted losses for a plurality of SNRs utilizing a first loss function and the CE model is retrained utilizing a second loss function that is constructed by using the obtained unweighted losses.

In one embodiment, the CE model may be trained based on loss discrepancies at different signal to noise ratio (SNR) values utilizing a loss function given as:

$$Loss = \{ \begin{matrix}{Loss}_{MSE} & if SNR < 0 \\ {Loss}_{{L}_{2}} & if SNR \geq 0\end{matrix}$$

if loss function values across all of SNRs of interest are less than 1, or

$$Loss = \{ \begin{matrix}{Loss}_{{L}_{2}} & if SNR < 0 \\ {Loss}_{MSE} & if SNR \geq 0\end{matrix}$$

if the loss function values across all of the SNRs of interest are greater than 1, where Loss_{MSE} is a mean squared error (MSE) loss, and Loss_{L}_{₂} is a square root of the Loss_{MSE}.

In one embodiment, the method 1300 may further include inputting, to the CE model, a channel metric including at least one of a power delay profile or a signal to noise ratio.

In one embodiment, the first domain may be a frequency-antenna domain, and the second domain may include a delay domain, a delay-antenna domain or a delay-angular domain. Transforming the noisy image into the second domain may include one of: applying, to frequencies of the noisy image, a one-dimensional (1-D) transform including a 1-D inverse discrete Fourier transform (IDFT) or a 1-D inverse wavelet transform, and subsequently applying, to antennas of the noisy image, a 1-D transform including a 1-D discrete Fourier transform (DFT) or a 1-D wavelet transform; applying a two-dimensional (2-D) transform directly to the noisy image; applying, to frequencies of the noisy image, the 1-D transform including the 1-D IDFT or the 1-D inverse wavelet transform, and subsequently applying a 1-D transform to each antenna polarization of a 1-D shape separately and concatenating two transformed vectors into one vector; applying, to frequencies of the noisy image, the 1-D transform including the 1-D IDFT or the 1-D inverse wavelet transform, and subsequently applying a 2-D transform to each antenna polarization of a 2-D shape separately and concatenating two transformed vectors into one vector; or applying, to the frequencies of the noisy image, the 1-D transform including the 1-D IDFT or the 1-D inverse wavelet transform without applying a transform to the antennas of the noisy image.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method for channel estimation, the method comprising:
receiving, by a first electronic device, a signal indicative of a state of a channel from a second electronic device, the signal being associated with a channel matrix and corrupted by a noise;
obtaining a noisy image of the channel in a first domain, the noisy image being a least squares estimate of the channel matrix;
transforming the noisy image into a second domain; and
performing channel estimation (CE) of the channel based on (i) the transformed noisy image, (ii) a CE model configured to denoise an input signal, and (iii) a sparsity of channel state information (CSI) in the transformed noisy image in the second domain.

2. The method of claim 1, wherein:
the CE model comprises a first neural network including residual learning networks (ResNets) configured to utilize a two-dimensional convolution and a second neural network configured to perform a zero-out function, and
performing the CE of the channel comprises:
splitting the transformed noisy image into a first part including the CSI and a second part including the noise, the first part including a top portion of the transformed noisy image and a bottom portion of the transformed noisy image, the second part disposed between the top and bottom portions;
moving the bottom portion to the top portion such that the top and bottom portions are contiguous;
inputting the first part into the first neural network and the second part into the second neural network;
denoising, by the first neural network, the first part;
denoising, by the second neural network, the second part;
concatenating the denoised first part and the denoised second part into a denoised image having an original size of the transformed noisy image;
moving the denoised bottom portion of the denoised image below the denoised second portion of the denoised image; and
de-transforming the denoised image into the first domain.

3. The method of claim 1, wherein:
the CE model comprises a first neural network including residual learning networks (ResNets) configured to utilize a two-dimensional convolution and a second neural network including ResNets configured to utilize a depth-wise separable convolution that includes a depth-wise convolution and a point-wise convolution, and
performing the CE of the channel comprises:
splitting the transformed noisy image into a first part including the CSI and a second part including the noise, the first part including a top portion of the transformed noisy image and a bottom portion of the transformed noisy image, the second part disposed between the top and bottom portions;
moving the bottom portion to the top portion such that the top and bottom portions are contiguous;
inputting the first part into the first neural network and the second part into the second neural network;
denoising, by the first neural network, the first part;
denoising, by the second neural network, the second part;
concatenating the denoised first part and the denoised second part into a denoised image having an original size of the transformed noisy image;
moving the denoised bottom portion of the denoised image below the denoised second portion of the denoised image; and
de-transforming the denoised image into the first domain.

4. The method of claim 1, wherein:
the CE model is trained based on a per signal to noise ratio (SNR) training algorithm to obtain unweighted losses for a plurality of SNRs utilizing a first loss function, and
the CE model is retrained utilizing a second loss function that is constructed by using the obtained unweighted losses.

5. The method of claim 1, wherein the CE model is trained based on loss discrepancies at different signal to noise ratio (SNR) values utilizing a loss function given as:
$$Loss = \{ \begin{matrix}{Loss}_{MSE} & if SNR < 0 \\ {Loss}_{{L}_{2}} & if SNR \geq 0\end{matrix}$$
if loss function values across all of SNRs of interest are less than 1, or
$$Loss = \{ \begin{matrix}{Loss}_{{L}_{2}} & if SNR < 0 \\ {Loss}_{MSE} & if SNR \geq 0\end{matrix}$$
if the loss function values across all of the SNRs of interest are greater than 1,
where Loss_{MSE} is a mean squared error (MSE) loss, and Loss, is a square root of the Loss_{MSE}.

6. The method of claim 1, further comprising inputting, to the CE model, a channel metric including at least one of a power delay profile or a signal to noise ratio.

7. The method of claim 1, wherein:
the first domain is a frequency-antenna domain and the second domain comprises a delay domain, a delay-antenna domain or a delay-angular domain, and
transforming the noisy image into the second domain comprises one of:
applying, to frequencies of the noisy image, a one-dimensional (1-D) transform comprising a 1-D inverse discrete Fourier transform (IDFT) or a 1-D inverse wavelet transform, and subsequently applying, to antennas of the noisy image, a 1-D transform comprising a 1-D discrete Fourier transform (DFT) or a 1-D wavelet transform,
applying a two-dimensional (2-D) transform directly to the noisy image,
applying, to frequencies of the noisy image, the 1-D transform comprising the 1-D IDFT or the 1-D inverse wavelet transform, and subsequently applying a 1-D transform to each antenna polarization of a 1-D shape separately and concatenating two transformed vectors into one vector,
applying, to frequencies of the noisy image, the 1-D transform comprising the 1-D IDFT or the 1-D inverse wavelet transform, and subsequently applying a 2-D transform to each antenna polarization of a 2-D shape separately and concatenating two transformed vectors into one vector, or
applying, to the frequencies of the noisy image, the 1-D transform comprising the 1-D IDFT or the 1-D inverse wavelet transform without applying a transform to the antennas of the noisy image.

8. A first electronic device comprising:
memory; and
a processor operably coupled to the memory, the processor configured to:
receive a signal indicative of a state of a channel from a second electronic device, the signal being associated with a channel matrix and corrupted by a noise;
obtain a noisy image of the channel in a first domain, the noisy image being a least squares estimate of the channel matrix;
transform the noisy image into a second domain; and
perform channel estimation (CE) of the channel based on (i) the transformed noisy image, (ii) a CE model configured to denoise an input signal, and (iii) a sparsity of channel state information (CSI) in the transformed noisy image in the second domain.

9. The first electronic device of claim 8, wherein:
the CE model comprises a first neural network including residual learning networks (ResNets) configured to utilize a two-dimensional convolution and a second neural network configured to perform a zero-out function, and
to perform the CE of the channel, the processor is further configured to:
split the transformed noisy image into a first part including the CSI and a second part including the noise, the first part including a top portion of the transformed noisy image and a bottom portion of the transformed noisy image, the second part disposed between the top and bottom portions;
move the bottom portion to the top portion such that the top and bottom portions are contiguous;
input the first part into the first neural network and the second part into the second neural network;
denoise the first part via the first neural network;
denoise the second part via the second neural network;
concatenate the denoised first part and the denoised second part into a denoised image having an original size of the transformed noisy image;
move the denoised bottom portion of the denoised image below the denoised second portion of the denoised image; and
de-transform the denoised image into the first domain.

10. The first electronic device of claim 8, wherein:
the CE model comprises a first neural network including residual learning networks (ResNets) configured to utilize a two-dimensional convolution and a second neural network including ResNets configured to utilize a depth-wise separable convolution that includes a depth-wise convolution and a point-wise convolution, and
to perform the CE of the channel, the processor is further configured to:
split the transformed noisy image into a first part including the CSI and a second part including the noise, the first part including a top portion of the transformed noisy image and a bottom portion of the transformed noisy image, the second part disposed between the top and bottom portions;
move the bottom portion to the top portion such that the top and bottom portions are contiguous;
input the first part into the first neural network and the second part into the second neural network;
denoise the first part via the first neural network;
denoise the second part via the second neural network;
concatenate the denoised first part and the denoised second part into a denoised image having an original size of the transformed noisy image;
move the denoised bottom portion of the denoised image below the denoised second portion of the denoised image; and
de-transform the denoised image into the first domain.

11. The first electronic device of claim 8, wherein:
the CE model is trained based on a per signal to noise ratio (SNR) training algorithm to obtain unweighted losses for a plurality of SNRs utilizing a first loss function, and
the CE model is retrained utilizing a second loss function that is constructed by using the obtained unweighted losses.

12. The first electronic device of claim 8, wherein the CE model is trained based on loss discrepancies at different signal to noise ratio (SNR) values utilizing a loss function given as:
$$Loss = \{ \begin{matrix}{Loss}_{MSE} & if SNR < 0 \\ {Loss}_{{L}_{2}} & if SNR \geq 0\end{matrix}$$
if loss function values across all of SNRs of interest are less than 1, or
$$Loss = \{ \begin{matrix}{Loss}_{{L}_{2}} & if SNR < 0 \\ {Loss}_{MSE} & if SNR \geq 0\end{matrix}$$
if the loss function values across all of the SNRs of interest are greater than 1,
where Loss_{MSE} is a mean squared error (MSE) loss, and Loss, is a square root of the Loss_{MSE}.

13. The first electronic device of claim 8, wherein the processor is further configured to input to the CE model, a channel metric including at least one of a power delay profile or a signal to noise ratio.

14. The first electronic device of claim 8, wherein:
the first domain is a frequency-antenna domain and the second domain comprises a delay domain, a delay-antenna domain or a delay-angular domain, and
to transform the noisy image into the second domain, the processor is further configured to:
apply, to frequencies of the noisy image, a one-dimensional (1-D) transform comprising a 1-D inverse discrete Fourier transform (IDFT) or a 1-D inverse wavelet transform, and subsequently applying, to antennas of the noisy image, a 1-D transform comprising a 1-D discrete Fourier transform (DFT) or a 1-D wavelet transform,
apply a two-dimensional (2-D) transform directly to the noisy image,
apply, to frequencies of the noisy image, the 1-D transform comprising the 1-D IDFT or the 1-D inverse wavelet transform, and subsequently applying a 1-D transform to each antenna polarization of a 1-D shape separately and concatenating two transformed vectors into one vector,
apply, to frequencies of the noisy image, the 1-D transform comprising the 1-D IDFT or the 1-D inverse wavelet transform, and subsequently applying a 2-D transform to each antenna polarization of a 2-D shape separately and concatenating two transformed vectors into one vector, or
apply, to the frequencies of the noisy image, the 1-D transform comprising the 1-D IDFT or the 1-D inverse wavelet transform without applying a transform to the antennas of the noisy image.

15. A non-transitory computer readable medium embodying a computer program, the computer program comprising program code that, when executed by a processor of a first electronic device, causes the first electronic device to:
receive a signal indicative of a state of a channel from a second electronic device, the signal being associated with a channel matrix and corrupted by a noise;
obtain a noisy image of the channel in a first domain, the noisy image being a least squares estimate of the channel matrix;
transform the noisy image into a second domain; and
perform channel estimation (CE) of the channel based on (i) the transformed noisy image, (ii) a CE model configured to denoise an input signal, and (iii) a sparsity of channel state information (CSI) in the transformed noisy image in the second domain.

16. The non-transitory computer readable medium of claim 15, wherein:
the CE model comprises a first neural network including residual learning networks (ResNets) configured to utilize a two-dimensional convolution and a second neural network configured to perform a zero-out function, and
the program code that, when executed by the processor of the first electronic device, causes the first electronic device to perform the CE of the channel comprises program code that, when executed by the processor of the first electronic device, causes the first electronic device to:
split the transformed noisy image into a first part including the CSI and a second part including the noise, the first part including a top portion of the transformed noisy image and a bottom portion of the transformed noisy image, the second part disposed between the top and bottom portions;
move the bottom portion to the top portion such that the top and bottom portions are contiguous;
input the first part into the first neural network and the second part into the second neural network;
denoise the first part via the first neural network;
denoise the second part via the second neural network;
concatenate the denoised first part and the denoised second part into a denoised image having an original size of the transformed noisy image;
move the denoised bottom portion of the denoised image below the denoised second portion of the denoised image; and
de-transform the denoised image into the first domain.

17. The non-transitory computer readable medium of claim 15, wherein:
the CE model comprises a first neural network including residual learning networks (ResNets) configured to utilize a two-dimensional convolution and a second neural network including ResNets configured to utilize a depth-wise separable convolution that includes a depth-wise convolution and a point-wise convolution, and
the program code that, when executed by the processor of the first electronic device, causes the first electronic device to perform the CE of the channel comprises program code that, when executed by the processor of the first electronic device, causes the first electronic device to:
split the transformed noisy image into a first part including the CSI and a second part including the noise, the first part including a top portion of the transformed noisy image and a bottom portion of the transformed noisy image, the second part disposed between the top and bottom portions;
move the bottom portion to the top portion such that the top and bottom portions are contiguous;
input the first part into the first neural network and the second part into the second neural network;
denoise the first part via the first neural network;
denoise the second part via the second neural network;
concatenate the denoised first part and the denoised second part into a denoised image having an original size of the transformed noisy image;
move the denoised bottom portion of the denoised image below the denoised second portion of the denoised image; and
de-transform the denoised image into the first domain.

18. The non-transitory computer readable medium of claim 15, wherein:
the CE model is trained based on a per signal to noise ratio (SNR) training algorithm to obtain unweighted losses for a plurality of SNRs utilizing a first loss function, and
the CE model is retrained utilizing a second loss function that is constructed by using the obtained unweighted losses.

19. The non-transitory computer readable medium of claim 15, wherein the CE model is trained based on loss discrepancies at different signal to noise ratio (SNR) values utilizing a loss function given as:
$$Loss = \{ \begin{matrix}{Loss}_{MSE} & if SNR < 0 \\ {Loss}_{{L}_{2}} & if SNR \geq 0\end{matrix}$$
if loss function values across all of SNRs of interest are less than 1, or
$$Loss = \{ \begin{matrix}{Loss}_{{L}_{2}} & if SNR < 0 \\ {Loss}_{MSE} & if SNR \geq 0\end{matrix}$$
if the loss function values across all of the SNRs of interest are greater than 1,
where Loss_{MSE} is a mean squared error (MSE) loss, and Loss_{L}_{₂} is a square root of the Loss_{MSE}.

20. The non-transitory computer readable medium of claim 15, further comprising program code that, when executed by the processor of the first electronic device, causes the first electronic device to input to the CE model a channel metric including at least one of a power delay profile or a signal to noise ratio.
